(19) United States
(12) Patent Application Publication
(10) Pub. No.: US 2005/0121544 A1
(43) Pub. Date: Jun. 9, 2005

(54) Extendable mister with optional light

(76) Inventor: Seann Pavlik, Ft. Lauderdale, FL (US)

Correspondence Address: NIXON & VANDERHYE, PC, 1100 N GLEBE ROAD, 8TH FLOOR, ARLINGTON, VA, 22201-4714, US

(21) Appl. No.: 10/729,845

(22) Filed: Dec. 8, 2003

(51) Int. Cl. B05B 1/30

(52) U.S. Cl. 239/570

(57) ABSTRACT

An extendable misting apparatus includes a housing having a recess surrounded by a radial flange at one end, and a hydraulic fitting at an opposite end, the recess defined in part by a bearing block. A hollow piston rod is mounted for axial reciprocating movement in the housing between retracted and extended positions, the piston rod passing through the bearing block and having a misting head fixed to one end thereof and adapted to be received in the recess when the hollow piston is in the retracted position. At least one misting nozzle is mounted in the misting head and in fluid communication with the hollow piston rod and the hydraulic fitting. A spring is located in a chamber defined by the piston and the bearing block, normally biasing the piston rod to the retracted position.

### BACKGROUND OF THE INVENTION

There are many situations where it is desired to provide evaporative cooling in an area, or of people or other living beings (such as plants or animals) within the area. For that purpose, low pressure (under 100 psi), medium pressure (100-under 200 psi), and high pressure (200+ psi) systems are commercially available. However, most such systems are constructed without aesthetics in mind, and provide a number of non-aesthetic components in clear view. Also, most of such systems are provided as add-on structures, and are not successfully integrated into already existing or common structures, for a particular environment, and may be exposed to damage or corrosion.

Examples of current misting systems may be found in U.S. Pat. Nos. 5,628,273; 6,175,969 and 6,262,826. These systems are utilized in a marine environment and provide evaporative cooling in designated areas on watercraft.

It is desirable to provide misting systems that are compact and unobtrusive. In a related, commonly owned application Ser. No. 10/678,173 (atty. dkt. 4442-7), entitled “Water Misting System And Method,” filed Oct. 6, 2003, there is disclosed a misting system that is incorporated into existing boat components such as railings, canopy frames, and the like. This invention extends the concept in a unique manner to other applications.

### BRIEF DESCRIPTION OF THE INVENTION

According to the present invention, an extendable and retractable misting apparatus is provided that has a number of advantages. Regardless of the environment in which the invention is used, it can provide high pressure (typically between about 200-1000 psi) misting that cools very efficiently. Also, the invention is aesthetic, in that it is built-in to existing support structures, with no obtrusive component parts. By integrating the components of the misting system into already existing support structures, e.g., ceilings or ceiling light fixtures, the number of required parts is reduced and at least some mechanical and/or corrosion protection is provided for the system components.

More specifically, in one exemplary embodiment, a retractable mister assembly includes a cylindrical housing that is adapted for mounting in a ceiling or other support structure. One end of the housing is provided with a radial flange that is adapted to engage the visible or external surface of the ceiling or support structure, preferably in an outdoor environment. A hollow piston rod is supported in the housing and includes a misting head at one end thereof projecting beyond the housing. The opposite end of the piston rod remains inside the housing and is formed with an integral piston. A coil spring biases the piston rod and misting head to a normally retracted position, with the misting head seated within an external recess formed in the housing. At the same time, the misting head may be provided with a cover plate so that when in the retracted position, the misting assembly exhibits a clean, non-obtrusive appearance.

The misting head is fitted with one or more nozzles adapted to supply a fine mist under high pressure (200-1000 psi) to an area to be cooled.

In a second embodiment, the misting head incorporates a light fixture, and in order to accommodate the latter, the recess in the housing is enlarged in both diameter and length (if necessary). While the description is phrased in terms of a misting apparatus that incorporates a light fixture, it will be apparent to those of ordinary skill in the art that the invention extends to light fixtures that incorporate a misting head as well.

Accordingly, in one aspect, the present invention relates to an extendable misting apparatus comprising a housing having a recess surrounded by a radial flange at one end, and a hydraulic fitting at an opposite end, the recess defined in part by a bearing block; a hollow piston rod mounted for axial reciprocating movement in the housing between retracted and extended positions, the piston rod passing through the bearing block and having a misting head fixed to one end thereof adapted to be received in the recess when the hollow piston is in the retracted position; at least one misting nozzle mounted in the misting head and in fluid communication with the hollow piston rod and the hydraulic fitting; and a spring located in a chamber defined by the piston and the bearing block, normally biasing the piston rod to the retracted position.

In another aspect, the invention relates to an overhead misting apparatus comprising an elongated housing having a flange at one end and a hydraulic fitting at an opposite end, the housing adapted to project behind an exteriorly visible surface of the support structure, with a back side of the radial flange engaged with the exteriorly visible surface; a misting head including at least one misting nozzle secured at one end of a piston rod mounted for reciprocating movement in the housing between extended and retracted positions, the housing having an open-ended recess surrounded by the flange and adapted to receive the misting head in the retracted position.

In still another aspect, the invention relates to a misting apparatus for attachment to overhead structures and for supplying cooled air to a designated outdoor area comprising a housing having a flange at a first end and a hydraulic fitting at a second opposite end; a bearing block axially between said first and second ends thereby defining a chamber between the hydraulic fitting and one side of the bearing block and an open recess between the other side of the bearing block and the flange; a piston rod slidable within the housing including through the bearing block and having a piston at one end within the chamber, with a coil spring arranged about the piston rod and engaged with the piston and the bearing block; a misting head fixed to an opposite end of the piston rod including at least one misting nozzle; wherein a flowpath is established from the hydraulic fitting through the piston rod to the misting head and the misting nozzle and further wherein fluid entering the chamber acts upon the piston to drive the piston rod and the misting head from a retracted position where the misting head is received within the recess to an extended position wherein the at least one misting nozzle extends outwardly beyond the flange.

In still another aspect, the invention relates to a ceiling light and misting assembly comprising a housing having a flange at a first end and a hydraulic fitting at a second opposite end; a bearing block axially between the first and second ends thereby defining a chamber between the hydraulic fitting and one side of the bearing block and an open recess between the other side of the bearing block and the flange; a piston rod slidable within the housing including through the bearing block and having a piston at one end within the chamber, with a coil spring arranged about the piston rod and engaged with the piston and the bearing block; a misting head fixed to an opposite end of the piston rod including a light fixture and at least one misting nozzle; wherein a flowpath is established from the hydraulic fitting through the piston rod to the misting head and the misting nozzle and further wherein fluid entering the chamber acts upon the piston to drive the piston rod, the misting head and the light fixture from a retracted position where said misting head is received within the recess to an extended position wherein the at least one misting nozzle extends outwardly beyond the flange.

The invention will now be described in detail in connection with the drawings identified below.

### BRIEF DESCRIPTION OF THE DRAWINGS

FIG. 1 is a sectioned perspective view of an extendable misting apparatus in accordance with one exemplary embodiment of the invention; and

FIG. 2 is a sectional perspective view of a combined extendable misting apparatus and light fixture in accordance with another exemplary embodiment of the invention.

### DETAILED DESCRIPTION OF THE INVENTION

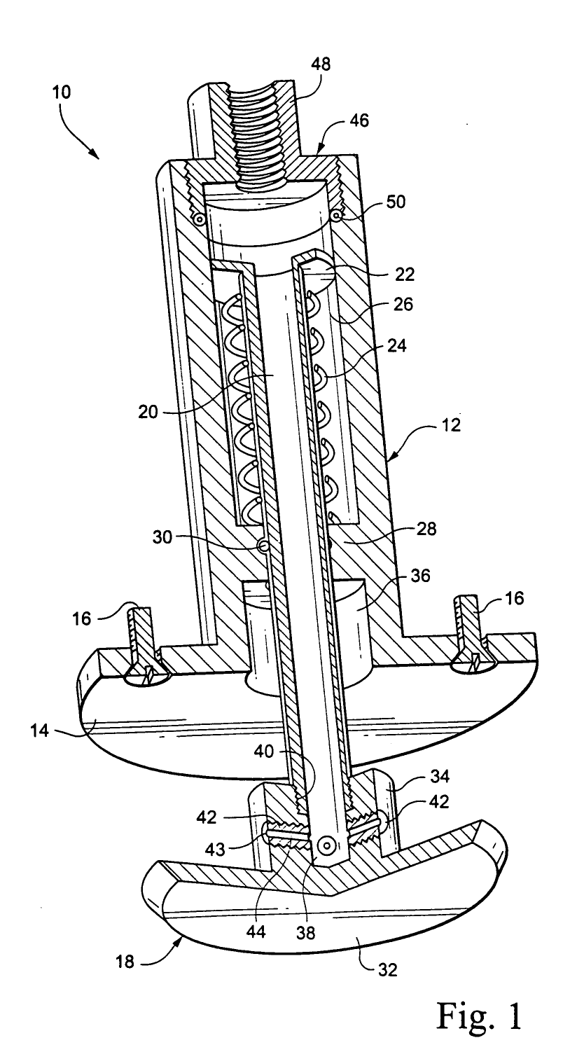

With initial reference to FIG. 1, an extendable mister assembly 10 comprises a cylindrical housing 12 that may be mounted in, for example, a porch ceiling, gazebo roof, boat deck cover, or any other supporting structure associated with enclosed or semi-enclosed outdoor areas. The housing 12 is provided with a radial flange 14 that would typically be exposed, and may include screw fasteners 16 or other means for securing the plate to a support structure. In other words, the back side of flange 14 is adapted to engage the external side of a ceiling panel or the like.

A mister head 18 is supported at one end of a hollow piston rod 20 mounted for reciprocating movement within the interior of the housing 12, and operable to extend and retract the misting head 18 as further explained below. The opposite end of piston rod 20 is formed with an integral piston 22. A coil spring 24 extends within a variable volume chamber 26 defined by the piston 22 and a fixed piston rod bearing block 28. The latter may be formed integrally with, or as an attachment to the housing 12, and includes an O-ring seal 30 that prevents leakage of water along the piston rod.

The mister head 18 includes a disk-like cover plate 32 overlying a smaller diameter, integral nozzle housing 34 that is adapted to be received in an external recess 36 formed in the housing 12, axially between the bearing 28 and the radial flange 14. The misting head 18 is in a retracted position when the nozzle housing 34 is fully seated in the recess 36 and the plate 32 lies flat on the radial flange 14. Thus, when not in use, the misting apparatus is essentially hidden behind the flange 14 and cover plate 32 that, if desired, may be supplied in any number of decorative styles.

The nozzle housing 34 is formed with a blind bore 38 and is counterbored at 40 and threaded to permit attachment of the mister head 18 to the externally threaded end of the hollow piston rod 20.

A plurality of mister nozzles 42 (three shown) are arranged at 90° intervals about the nozzle housing 34. The nozzles are threaded into the nozzle housing such that the nozzle discharge orifices are substantially flush with the outer surface of housing 34 and communicate via internal nozzle bores 44 with the bore 38 in the housing 34. Nozzles 42 may be of the type sold by Fogco Systems, Ltd., of New Castle-on-Tyne, U. K., and are preferably constructed of brass or steel. Each individual nozzle 42 may include one or more nozzle orifices 43 (not drawn to scale), each having a diameter of between about 0.2-0.5 mm. When supplied with water at a pressure of between about 200-1000 psi, the orifice(s) 43 of the nozzle(s) 42 deliver a mist of water droplets having a maximum cross sectional dimension of between about 5-100 microns. This provides maximum flash evaporative cooling (the latent heat of evaporation of water is about 600 calories/gm) to reduce the temperature in the area to be cooled by about 12-15° F.

At the opposite end of housing 12, a T-fitting 46 is threaded into the housing and an internally threaded stem portion 48 is adapted to receive a correspondingly threaded end of a water supply tube or pipe. An O-ring 50 provides for a water-tight connection. A flow path is thus established from the supply fitting 46, through the hollow piston rod 20, bore 38 and bores 44 of nozzles 42. Water may be supplied by means of any suitable pump capable of supplying water to the nozzles at pressures between about 200-1000 psi. For example, one suitable pressurizing pump is a Triplex Direct Drive Plunger Pump Model 2SF sold by Cat Pumps of Minneapolis, Minn.

In use, upon the introduction of water under pressure into the housing 12, pressure on the piston 22 will drive the misting head 18 outwardly (overcoming the counter force of spring 24), away from the flange 14 to an extended position, exposing the misting nozzles 42 and thereby permitting mist to be discharged into the area to be cooled. When the water pressure is turned off, the coil spring 24 will exert sufficient force on the piston 22 to return the misting head 18 to a retracted position, with housing 34 seated in recess 36 and cover plate 38 engaged with the housing flange 14.

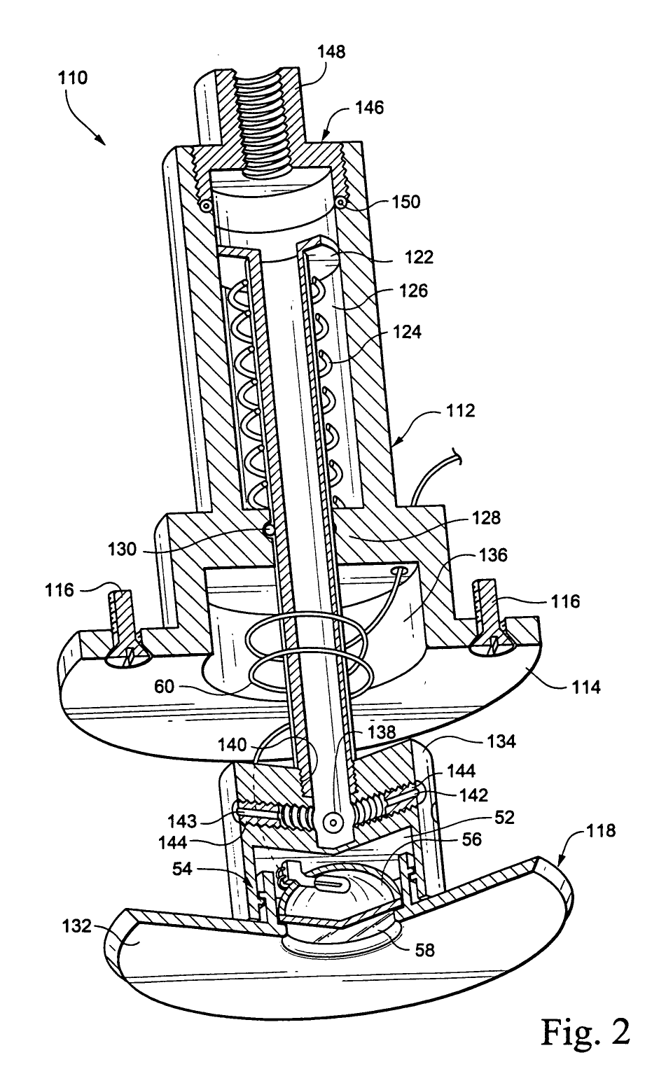

FIG. 2 illustrates a second embodiment of the invention where the misting head incorporates (or is incorporated in) a light fixture. Because of the overall similarities of the devices in FIGS. 1 and 2, similar reference numerals are used in FIG. 2 as used in FIG. 1, but with the prefix “1” added. In this embodiment, the nozzle housing 134 is axially lengthened to create a light cavity or recess 52 that is open to the exposed side of the cover plate 132. Note that in this embodiment, the cover plate 132 is separable from the nozzle/light housing 134 by a conventional twist-lock arrangement shown generally at 54. A light fixture 56 is secured within the housing 134 and a suitable lens 58 may cover the fixture. To accommodate the larger housing 134, the recess 136 in the housing 112 is enlarged by increasing the diameter (and length if necessary) of housing 112 forward of the bearing block 128. An electrical wire 60 may then extend from the light fixture, through the housing 134, recess 136 and bearing block 128. The extension and retraction of the misting head 118 remains as described above.

Note that in both FIGS. 1 and 2, the heads 18 and 118 are shown overextended. In use, the respective inner edge of the nozzle housing 34 and nozzle/light housing 134 need not extend beyond the flanges 14, 114, respectively. The housings need extend only to the point that nozzles 42, 142 are fully exposed. The choice of spring constant in relation to water pressure will determine the extent of travel of the piston rods.

In addition, while the FIG. 2 embodiment has been described in terms of a modification of the FIG. 1 embodiment, it will be understood that the invention also embraces conventional light fixtures that are modified to include an extendable and retractable misting head.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. An extendable misting apparatus comprising a housing having a recess surrounded by a radial flange at one end, and a hydraulic fitting at an opposite end, said recess defined in part by a bearing block; a hollow piston rod mounted for axial reciprocating movement in said housing between retracted and extended positions, said piston rod passing through said bearing block and having a misting head fixed to one end thereof adapted to be received in said recess when said hollow piston is in said retracted position; at least one misting nozzle mounted in said misting head and in fluid communication with said hollow piston rod and said hydraulic fitting; and a spring located in a chamber defined by said piston and said bearing block, normally biasing said piston rod to said retracted position.

2. The apparatus of claim 1 wherein said bearing includes an O-ring seal engaged with said piston rod.

3. The apparatus of claim 1 wherein said misting head further comprises a cover plate that conceals said at least one nozzle when said misting head is received in said recess in said retracted position.

4. The apparatus of claim 1 wherein said piston rod has a piston at an opposite end of said piston rod, said piston and piston rod adapted to be driven to said extended position by water entering said housing via said hydraulic fitting.

5. The apparatus of claim 1 wherein said misting head incorporates a light fixture.

6. The apparatus of claim 5 wherein said light fixture is located downstream of said at least one misting nozzle.

7. The apparatus of claim 1 wherein at least one misting nozzle comprises four misting nozzles arranged at substantially 90° intervals about said misting head.

8. An overhead misting apparatus comprising an elongated housing having a flange at one end and a hydraulic fitting at an opposite end, said housing adapted to project behind an exteriorly visible surface of said support structure, with a back side of said radial flange engaged with said exteriorly visible surface;
a misting head including at least one misting nozzle secured at one end of a piston rod mounted for reciprocating movement in said housing between extended and retracted positions, said housing having an open-ended recess surrounded by said flange and adapted to receive said misting head in said retracted position.

9. The apparatus of claim 8 wherein said exteriorly visible surface comprises an outdoor ceiling.

10. The apparatus of claim 8 wherein a coil spring is arranged in said housing to bias said piston rod and said misting head toward said retracted position.

11. The apparatus according to claim 8 and further comprising a piston at an opposite end of said piston rod exposed to water under pressure entering said housing via said hydraulic fitting to thereby move said piston rod and said misting head to said extended position.

12. The apparatus of claim 8 and further comprising a bearing block in said housing through which said piston rod passes, and further wherein said bearing block includes an O-ring seal engaged with said piston rod.

13. The apparatus of claim 8 wherein said misting head further comprises a cover plate that conceals said at least one nozzle when said misting head is received in said recess in said retracted position.

14. The apparatus of claim 8 wherein said misting head incorporates a light fixture.

15. The apparatus of claim 14 wherein said light fixture is located downstream of said at least one misting nozzle.

16. The apparatus of claim 8 wherein at least one misting nozzle comprises four misting nozzles arranged at substantially 90° intervals about said misting head.

17. A misting apparatus for attachment to overhead structures and for supplying cooled air to a designated outdoor area comprising a housing having a flange at a first end and a hydraulic fitting at a second opposite end; a bearing block axially between said first and second ends thereby defining a chamber between said hydraulic fitting and one side of said bearing block and an open recess between the other side of said bearing block and said flange; a piston rod slidable within said housing including through said bearing block and having a piston at one end within said chamber, with a coil spring arranged about said piston rod and engaged with said piston and said bearing block; a misting head fixed to an opposite end of said piston rod including at least one misting nozzle; wherein a flowpath is established from said hydraulic fitting through said piston rod to said misting head and said misting nozzle and further wherein fluid entering said chamber acts upon said piston to drive said piston rod and said misting head from a retracted position where said misting head is received within said recess to an extended position wherein said at least one misting nozzle extends outwardly beyond said flange.

18. The apparatus of claim 17 wherein said misting head is provided with a flat cover plate downstream of said at least one misting nozzle, said cover plate overlying at least a portion of said flange when said misting head is in said retracted position.

19. The apparatus of claim 18 wherein said cover plate is formed with a center hole in alignment with another recess formed in said misting head, and further wherein a light fixture is mounted within said another recess.

20. A ceiling light and misting assembly comprising a housing having a flange at a first end and a hydraulic fitting at a second opposite end; a bearing block axially between said first and second ends thereby defining a chamber between said hydraulic fitting and one side of said bearing block and an open recess between the other side of said bearing block and said flange; a piston rod slidable within said housing including through said bearing block and having a piston at one end within said chamber, with a coil spring arranged about said piston rod and engaged with said piston and said bearing block; a misting head fixed to an opposite end of said piston rod including a light fixture and at least one misting nozzle; wherein a flowpath is established from said hydraulic fitting through said piston rod to said misting head and said misting nozzle and further wherein fluid entering said chamber acts upon said piston to drive said piston rod, said misting head and said light fixture from a retracted position where said misting head is received within said recess to an extended position wherein said at least one misting nozzle extends outwardly beyond said flange.

21. The ceiling light and misting assembly of claim 20 wherein said misting head is formed with an open-ended recess downstream of said misting nozzle, said light fixture mounted in said open-ended recess.
